(19) United States
(12) Patent Application Publication
(10) Pub. No.: US 2025/0052435 A1
(43) Pub. Date: Feb. 13, 2025

(54) ELECTRONIC COMPONENT MOUNTING STRUCTURE AND OUTDOOR UNIT OF AIR CONDITIONER

(71) Applicant: Mitsubishi Electric Corporation, Tokyo (JP)

(72) Inventors: Hiroki SUZUKI, Tokyo (JP); Keiji HARADA, Tokyo (JP)

(21) Appl. No.: 18/722,848

(22) PCT Filed: Feb. 28, 2022
(86) PCT No.: PCT/JP2022/008364

§ 371 Date: Jun. 21, 2024

(51) Int. Cl. F24F 1/24

(52) U.S. Cl. CPC F24F 1/24

(57) ABSTRACT

An electronic component mounting structure includes an electronic component, a metal plate having one surface and another surface, and a heat dissipation component having flexibility and elasticity. The heat dissipation component is sandwiched between the one surface of the metal plate and the electronic component with a region of the heat dissipation component that faces the electronic component being deformed along the shape of the electronic component and being in intimate contact with the electronic component, and the heat dissipation component being in intimate contact with the one surface of the metal plate. The electronic component and the metal plate are thermally connected via the heat dissipation component.

### CROSS-REFERENCE TO RELATED APPLICATION

This application is a U.S. National Stage Application of PCT/JP2022/008364 filed on Feb. 28, 2022, the contents of which are incorporated herein by reference.

### FIELD

The present disclosure relates to an electronic component mounting structure and an outdoor unit of an air conditioner.

### BACKGROUND

In a power conversion circuit of an air conditioner, a coil as an electronic component is used in an alternating current unit for noise prevention/reduction, or used in a direct current unit for power factor improvement or harmonic current reduction. Regarding an electronic component mounting structure, various techniques have been proposed.

For example, Patent Literature 1 discloses a power converter including a toroidal coil. In the power converter described in Patent Literature 1, a coil cover accommodating a toroidal coil is in contact with a lower surface of a substrate. An opening of the coil cover and a protrusion protruding upward from the bottom of a housing of the power converter sandwich therebetween a heat dissipation sheet that transfers heat generated in the toroidal coil to the housing.

### Patent Literature

Patent Literature 1: Japanese Patent Application Laid-open No. 2020-188131

However, according to the technique of Patent Literature 1 above, the heat dissipation sheet has low flexibility and is not in intimate contact with the electronic component so that a contact area between the electronic component and the heat dissipation sheet is small, which has resulted in a problem that the heat generated in the toroidal coil is inefficiently transferred to the housing.

In addition, according to the technique of Patent Literature 1 above, there has been a problem that, due to vibration of the electronic component during transportation of the power converter, a joint portion between the electronic component and a substrate or a joint portion between the electronic component and the housing may experience a fatigue failure.

### SUMMARY

The present disclosure has been made in view of the above, and an object thereof is to provide an electronic component mounting structure that can enhance performance of dissipating heat of an electronic component and suppress vibration of the electronic component.

To solve the above problems and achieve an object, an electronic component mounting structure according to the present disclosure includes: an electronic component; a metal plate including one surface and another surface; and a heat dissipation component having flexibility and elasticity. The heat dissipation component is sandwiched between the one surface of the metal plate and the electronic component with a region of the heat dissipation component that faces the electronic component being deformed along a shape of the electronic component and being in intimate contact with the electronic component, and the heat dissipation component being in intimate contact with the one surface of the metal plate. The electronic component and the metal plate are thermally connected via the heat dissipation component.

The electronic component mounting structure according to the present disclosure has an effect of being able to enhance the performance of dissipating the heat of the electronic component and suppress the vibration of the electronic component.

### BRIEF DESCRIPTION OF DRAWINGS

FIG. 1 is a side view illustrating an electronic component mounting structure according to a first embodiment.

FIG. 2 is a top view illustrating the electronic component mounting structure according to the first embodiment.

FIG. 3 is a side view illustrating an electronic component mounting structure according to a second embodiment.

FIG. 4 is a top view illustrating the electronic component mounting structure according to the second embodiment.

FIG. 5 is an exploded side view illustrating an electronic component mounting structure according to a third embodiment.

FIG. 6 is a side view illustrating an electronic component mounting structure according to a fourth embodiment.

FIG. 7 is a top view illustrating the electronic component mounting structure according to the fourth embodiment.

FIG. 8 is a side view illustrating an electronic component mounting structure according to a fifth embodiment.

FIG. 9 is a top view illustrating the electronic component mounting structure according to the fifth embodiment.

FIG. 10 is a side view illustrating an electronic component mounting structure according to a sixth embodiment.

FIG. 11 is a top view illustrating the electronic component mounting structure according to the sixth embodiment.

FIG. 12 is a side view illustrating another electronic component mounting structure according to the sixth embodiment.

FIG. 13 is a top view illustrating the another electronic component mounting structure according to the sixth embodiment.

FIG. 14 is a block diagram illustrating a configuration of an air conditioner according to a seventh embodiment.

FIG. 15 is a refrigerant circuit diagram illustrating a refrigeration cycle of the air conditioner according to the seventh embodiment.

FIG. 16 is a first conceptual diagram illustrating a configuration of an outdoor unit of an air conditioner to which the electronic component mounting structure according to any one of the first embodiment to the sixth embodiment is attached.

FIG. 17 is a second conceptual diagram illustrating the configuration of the outdoor unit of the air conditioner to which the electronic component mounting structure according to any one of the first embodiment to the sixth embodiment is attached.

FIG. 18 is a third conceptual diagram illustrating the configuration of the outdoor unit of the air conditioner to which the electronic component mounting structure according to any one of the first embodiment to the sixth embodiment is attached.

### DETAILED DESCRIPTION

Hereinafter, an electronic component mounting structure and an outdoor unit of an air conditioner according to embodiments will be described in detail with reference to the drawings. Note that, in the drawings, common elements are assigned the same reference numerals, and redundant description will be omitted.

### First Embodiment

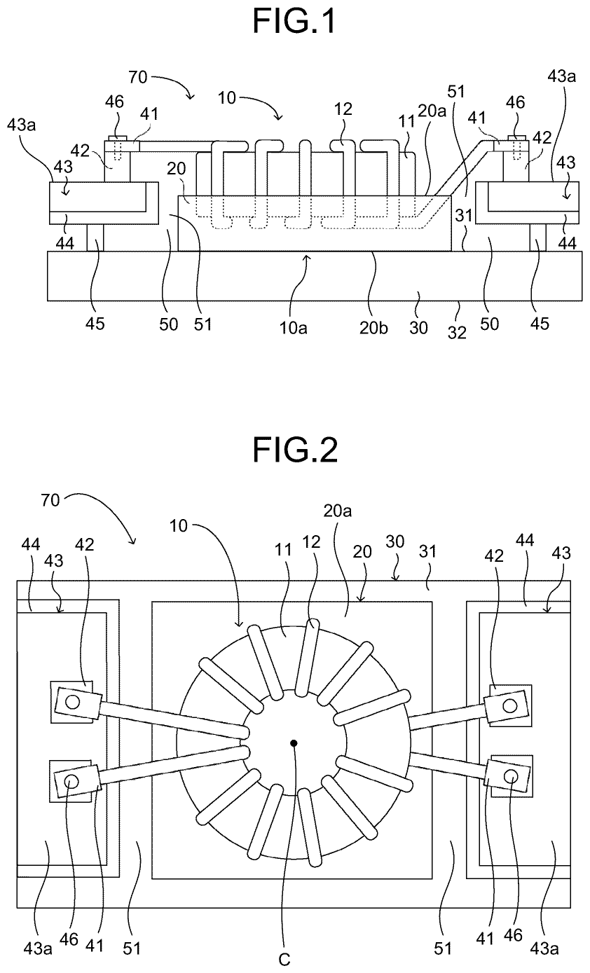

FIG. 1 is a side view illustrating an electronic component mounting structure 70 according to a first embodiment. FIG. 2 is a top view illustrating the electronic component mounting structure 70 according to the first embodiment. FIG. 2 illustrates a state viewed from above an electronic component 10.

The electronic component mounting structure 70 is a mounting structure of the electronic component 10 capable of suppressing vibration of the electronic component 10 and efficiently dissipating heat generated in the electronic component 10. As illustrated in FIG. 1, the electronic component mounting structure 70 includes the electronic component 10, a heat dissipation component 20 having flexibility and elasticity, and a metal plate 30 having one surface 31 and another surface 32. In the electronic component mounting structure 70, the heat dissipation component 20 and the electronic component 10 are mounted on the one surface 31 of the metal plate 30 in this order from the bottom. The one surface 31 of the metal plate 30 is an upper surface of the metal plate 30 that is a surface of the metal plate 30 on which the heat dissipation component 20 and the electronic component 10 are mounted.

Note that, in the first embodiment, a stacking direction in which the electronic component 10, the heat dissipation component 20, and the metal plate 30 are stacked as illustrated in FIG. 1 corresponds to a vertical direction. The vertical direction is a direction perpendicular to an in-plane direction of the one surface 31 and the another surface 32 of the metal plate 30. Moreover, the in-plane direction of the one surface 31 and the another surface 32 of the metal plate 30 is parallel to an upper surface 20a and a lower surface 20b of the heat dissipation component 20 described later.

The electronic component 10 is a toroidal coil including a core 11 and a winding 12 wound around the core 11, the core 11 being made of a magnetic material and having an annular shape in the in-plane direction of the one surface 31 of the metal plate 30. The electronic component 10 is placed and held on the heat dissipation component 20 while being laid transversely.

The electronic component 10 includes connection terminals 41 attached to ends of the winding 12. The electronic component 10 is connected, via the connection terminals 41, to terminal blocks 42 installed on electronic substrates 43 described later by screws 46.

Note that FIG. 1 illustrates the case where the connection terminals 41, the terminal blocks 42, and the screws 46 are used to connect the electronic component 10 and the electronic substrates 43, but the method of connecting the electronic component 10 and the electronic substrates 43 is not limited. For example, the electronic component 10 and the electronic substrates 43 may be connected by a method such as solder bonding.

The heat dissipation component 20 is sandwiched between the one surface 31 of the metal plate 30 and the electronic component 10. The heat dissipation component 20 has flexibility and elasticity. Flexibility is a property in which a material is easily deformed. Elasticity is a property in which a shape or volume of an object is changed when a force is applied thereto, and the shape or volume is restored when the applied force is removed, and is a property having a repulsive force by which an object tries to return to the original shape or volume when a force is applied thereto.

The heat dissipation component 20 is fixed to the one surface 31 of the metal plate 30 in a state in which the lower surface 20b of the heat dissipation component 20 and the one surface 31 of the metal plate 30 are in intimate contact with each other. In addition, with a lower side of the electronic component 10 pressed against the upper surface 20a of the heat dissipation component 20, the heat dissipation component 20 is in intimate contact with the electronic component 10 in a state in which, by flexibility of the heat dissipation component 20, the shape of a part of the heat dissipation component 20 on the side of the upper surface 20a is deformed along the shape of the electronic component 10 on the side of a lower surface 10a to be described later. The lower side of the electronic component 10 is a side of the electronic component 10 corresponding to the metal plate 30. The heat dissipation component 20 is deformed almost to the maximum in terms of flexibility to be able to hold the electronic component 10 in a state in which the electronic component 10 does not move on the heat dissipation component 20.

The upper surface 20a of the heat dissipation component 20 is a surface of the heat dissipation component 20 on a side where the electronic component 10 is disposed in the stacking direction. The lower surface 20b of the heat dissipation component 20 is a surface of the heat dissipation component 20 on a side where the metal plate 30 is disposed in the stacking direction.

For the heat dissipation component 20, for example, a heat dissipation sheet having insulation properties is used. For example, when the upper surface 20a of the heat dissipation component 20, which is a surface of the heat dissipation component 20 facing the lower portion of the electronic component 10, is made adhesive, the upper surface 20a of the heat dissipation component 20 and the lower portion of the electronic component 10 can be brought into intimate contact with each other such that the upper surface 20a of the heat dissipation component 20 and the lower portion of the electronic component 10 are not separated from each other. Note that a method of causing the upper surface 20a of the heat dissipation component 20 and the lower portion of the electronic component 10 to be in intimate contact with each other so as not to peel off from each other is not limited.

Moreover, for example, when the lower surface 20b of the heat dissipation component 20, which is a surface of the heat dissipation component 20 facing the one surface 31 of the metal plate 30, is made adhesive, the lower surface 20b of the heat dissipation component 20 and the one surface 31 of the metal plate 30 can be brought into intimate contact with each other such that the lower surface 20b of the heat dissipation component 20 and the one surface 31 of the metal plate 30 are not separated from each other. Note that a method of bringing the lower surface 20b of the heat dissipation component 20 and the one surface 31 of the metal plate 30 into intimate contact with each other is not limited.

The heat dissipation component 20 may be fixed while being stuck to the one surface 31 of the metal plate 30. Alternatively, contact surfaces between the heat dissipation component 20 and the metal plate 30, that is, the lower surface 20b of the heat dissipation component 20 and the one surface 31 of the metal plate 30 may be formed with unevenness that fits together. In this case, when the unevenness formed on the heat dissipation component 20 and the metal plate 30 fits together, the heat dissipation component 20 is fixed to the one surface 31 of the metal plate 30.

In addition, the heat dissipation component 20 has a function of dissipating heat generated in the electronic component 10 when the electronic component 10 operates. The heat dissipation component 20 is in direct contact with the lower portion of the electronic component 10 as described above, thereby being thermally connected to the electronic component 10. That is, the heat generated in the electronic component 10 is transferred to the heat dissipation component 20. The heat dissipation component 20 can then function as a heat dissipator that dissipates the heat of the electronic component 10 transferred from the electronic component 10.

Moreover, the heat dissipation component 20 is in direct contact with the one surface 31 of the metal plate 30 as described above, thereby being thermally connected to the metal plate 30. Thus, the heat dissipation component 20 has a function of transferring heat, which is generated in the electronic component 10 when the electronic component 10 operates, to the metal plate 30.

The metal plate 30 is a base substrate serving as a base on which the heat dissipation component 20 and the electronic component 10 are mounted in the electronic component mounting structure 70. Also, the metal plate 30 has a function of dissipating the heat generated in the electronic component 10 when the electronic component 10 operates. The metal plate 30 is thermally connected to the electronic component 10 via the heat dissipation component 20. That is, the heat generated in the electronic component 10 is transferred to the metal plate 30 via the heat dissipation component 20. The metal plate 30 then functions as a heat dissipator that dissipates the heat of the electronic component 10 transferred via the heat dissipation component 20.

In terms of the function of the base substrate and the function as the heat dissipator that dissipates the heat of the electronic component 10, the electronic component mounting structure 70 adopts the metal plate 30 made of metal that is a material having relatively high mechanical strength and thermal conductivity among various materials.

Moreover, as illustrated in FIG. 1, above the one surface 31 of the metal plate 30, two pieces of the electronic substrates 43 are disposed so as to sandwich the heat dissipation component 20 and the electronic component 10 in the in-plane direction of the one surface 31. On an upper surface 43a of each of the electronic substrates 43, the terminal block 42 is provided for electrically connecting the connection terminal 41, which is attached to the end of the winding 12 of the electronic component 10, and the electronic substrate 43. The upper surface 43a of the electronic substrate 43 is a surface opposite to a surface of the electronic substrate 43 facing the side of the metal plate 30. The electronic substrates 43 are each held and fixed by a substrate holder 44 made of a material such as resin.

The substrate holder 44 is attached and fixed to the metal plate 30 via a column 45 fixed to the one surface 31 of the metal plate 30. That is, the substrate holder 44 is disposed above and away from the one surface 31 of the metal plate 30, and holds the electronic substrate 43. A gap 50 is formed between the substrate holder 44 and the metal plate 30. Also, a gap 51 is formed between the substrate holder 44 and the heat dissipation component 20.

In the electronic component mounting structure 70, the gap 51 is formed between the heat dissipation component 20 and the substrate holder 44. Therefore, in the electronic component mounting structure 70, heat can be dissipated from a side surface of the heat dissipation component 20 facing the substrate holder 44.

In the electronic component mounting structure 70 having the configuration described above, the heat dissipation component 20 has flexibility, so that the heat dissipation component 20 on which the electronic component 10 is mounted holds the electronic component 10 with the upper surface 20a side of the heat dissipation component 20 being deformed along the shape of the lower portion of the electronic component 10. The electronic component 10 is thus held and fixed by the heat dissipation component 20 with the lower portion of the electronic component 10 being buried in the heat dissipation component 20 and being in intimate contact with the heat dissipation component 20 on the side of the upper surface 20a.

More specifically, in the heat dissipation component 20 on which the electronic component 10 is mounted, the heat dissipation component 20 on the side of the upper surface 20a is deformed along the shape of the winding 12 of the electronic component 10, which generates heat during the operation of the electronic component 10, and the shape of the core 11 which is in contact with the winding 12 and to which the heat generated in the winding 12 is transferred. The electronic component 10 is thus held and fixed by the heat dissipation component 20 with the lower portion of the electronic component 10 being buried in the heat dissipation component 20, which is deformed along the shape of the winding 12 and the shape of the core 11 in the lower portion of the electronic component 10, and with the winding 12 and the core 11 in the lower portion of the electronic component 10 being in intimate contact with the heat dissipation component 20 on the side of the upper surface 20a.

That is, in the electronic component mounting structure 70, the heat dissipation component 20 is deformed along the uneven shape of the lower portion of the electronic component 10 due to flexibility of the heat dissipation component 20, and is in intimate contact with the lower portion of the electronic component 10 along the uneven shape of the lower portion of the electronic component 10 to hold the electronic component 10.

Moreover, in the electronic component mounting structure 70, the heat dissipation component 20 has flexibility so that the lower surface 20b side of the heat dissipation component 20 mounted on the metal plate 30 can be deformed along the shape of the one surface 31 of the metal plate 30. That is, in the electronic component mounting structure 70, the heat dissipation component 20 is deformed along the uneven shape of the one surface 31 of the metal plate 30, and is fixed to the one surface 31 of the metal plate 30 in intimate contact therewith along the uneven shape of the one surface 31 of the metal plate 30.

Therefore, in the electronic component mounting structure 70, a large contact area is secured between the heat dissipation component 20 and the electronic component 10, and the adhesion between the heat dissipation component 20 and the electronic component 10 is enhanced. Moreover, in the electronic component mounting structure 70, a large contact area is secured between the heat dissipation component 20 and the metal plate 30, and the adhesion between the heat dissipation component 20 and the metal plate 30 is enhanced.

As a result, the electronic component mounting structure 70 can efficiently transfer the heat generated in the electronic component 10 during the operation of the electronic component 10 to the metal plate 30 via the heat dissipation component 20, can reduce the thermal resistance between the electronic component 10 and the metal plate 30, and can enhance the performance of dissipating the heat generated in the electronic component 10.

Moreover, in the electronic component mounting structure 70, the heat dissipation component 20 is in intimate contact with the electronic component 10 and the metal plate 30, so that even when vibration is applied to the electronic component mounting structure 70, vibration of the electronic component 10 can be suppressed. Thus, with the vibration of the electronic component 10 being suppressed, the connection terminals 41 or the terminal blocks 42, which are a connector between the electronic component 10 and the electronic substrates 43, do not experience a fatigue failure due to the vibration of the electronic component 10. The connector between the electronic component 10 and the electronic substrates 43 includes the connection terminals 41, the terminal blocks 42, and the screws 46.

Moreover, in the electronic component mounting structure 70, the gaps 51 are formed between the heat dissipation component 20 and the substrate holders 44, so that the substrate holders 44 do not obstruct the deformation of the heat dissipation component 20 in the in-plane direction of the one surface 31 of the metal plate 30. As a result, in the electronic component mounting structure 70, the heat dissipation component 20 is easily brought into intimate contact with the lower portion of the electronic component 10 along the shape of the lower portion of the electronic component 10, and is also easily brought into intimate contact with the one surface 31 of the metal plate 30 along the uneven shape of the one surface 31.

Moreover, in the electronic component mounting structure 70, the electronic component 10 has the annular shape in the in-plane direction of the one surface 31 of the metal plate 30 and is laid transversely. Then, in the electronic component mounting structure 70, the lower surface 10a of the electronic component 10, which is a surface orthogonal to a central axis C of the annular shape of the electronic component 10, is disposed in contact with the upper surface 20a of the heat dissipation component 20 while facing the upper surface 20a. The lower surface 10a of the electronic component 10 includes a lower surface of the core 11 and the winding 12 wound around the lower surface of the core 11.

In the electronic component mounting structure 70 having the configuration described above, the heat dissipation component 20 is attached to the lower surface 10a that is the surface orthogonal to the central axis C of the electronic component 10. That is, in the electronic component mounting structure 70, the electronic component 10 is mounted with the lower surface 10a facing the upper surface 20a of the heat dissipation component 20, the lower surface 10a being a surface having a relatively larger contact area with the upper surface 20a of the heat dissipation component 20, which is the surface of the heat dissipation component 20 on which the electronic component 10 is mounted, than with other surfaces of the heat dissipation component 20 when the electronic component 10 is laid transversely and mounted on the heat dissipation component 20. Therefore, it can be said that the electronic component 10 has the annular shape in the in-plane direction of the one surface 31 of the metal plate 30, and is disposed in the state in which the lower surface 10a orthogonal to the central axis C of the annular shape of the electronic component 10 faces and is in contact with the upper surface 20a of the heat dissipation component 20.

Therefore, in the electronic component mounting structure 70, a large contact area can be secured between the electronic component 10 and the heat dissipation component 20. As a result, in the electronic component mounting structure 70, the adhesion between the electronic component 10 and the heat dissipation component 20 is further enhanced, so that it is possible to more effectively prevent the connection terminals 41 or the terminal blocks 42, which are the connector between the electronic component 10 and the electronic substrates 43, from experiencing a fatigue failure due to the vibration of the electronic component 10.

Moreover, the electronic component mounting structure 70 can secure the large contact area between the electronic component 10 and the heat dissipation component 20, thereby being able to more effectively transfer the heat generated in the electronic component 10 during the operation of the electronic component 10 efficiently to the metal plate 30 via the heat dissipation component 20, reduce the thermal resistance between the electronic component 10 and the metal plate 30, and enhance the performance of dissipating the heat generated in the electronic component 10. Thus, by enhancing the performance of dissipating the heat generated in the electronic component 10, the electronic component mounting structure 70 can prevent an increase in temperature of the electronic component 10 and prevent malfunction of the electronic component 10 due to an increase in temperature of the electronic component 10.

Note that although the case where the electronic component 10 is the toroidal coil has been described above, the type of the electronic component 10 is not limited to the toroidal coil.

As described above, in the electronic component mounting structure 70, the heat dissipation component 20 having flexibility and elasticity is in intimate contact with the electronic component 10 and the metal plate 30, so that vibration of the electronic component 10 can be suppressed. As a result, in the electronic component mounting structure 70, it is possible to prevent the occurrence of a fatigue failure in the connector between the electronic component 10 and the electronic substrates 43 due to vibration of the electronic component 10 during product transportation.

Therefore, the electronic component mounting structure 70 according to the first embodiment has an effect of being able to enhance the performance of dissipating the heat of the electronic component 10 by enhancing the heat transfer performance from the electronic component 10 to the metal plate 30, and also to suppress the vibration of the electronic component 10.

### Second Embodiment

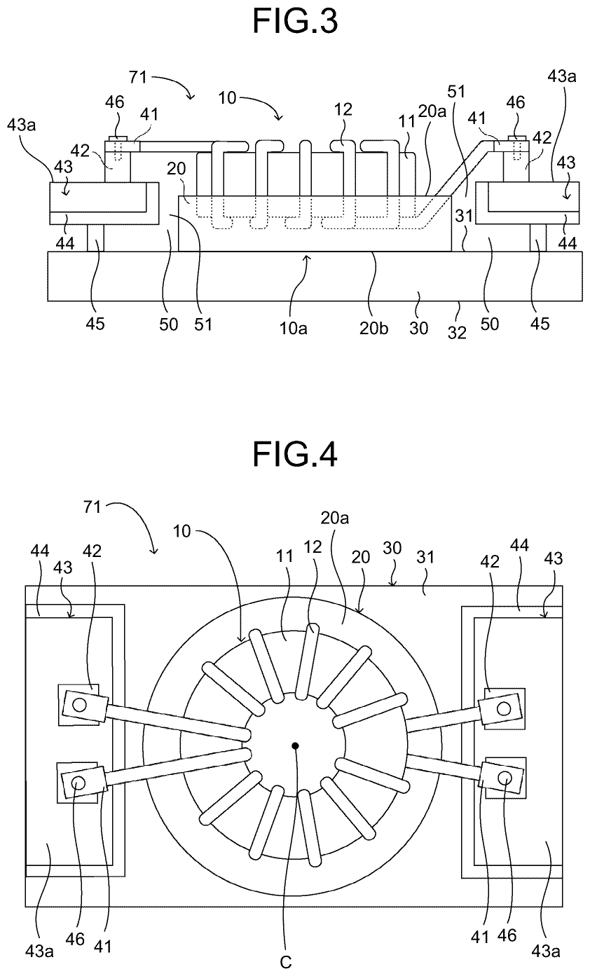

FIG. 3 is a side view illustrating an electronic component mounting structure 71 according to a second embodiment. FIG. 4 is a top view illustrating the electronic component mounting structure 71 according to the second embodiment. Note that in the second embodiment, components identical to those in the first embodiment described above are denoted by the same reference numerals as those assigned to such components in the first embodiment, and a detailed description thereof will be omitted.

The electronic component mounting structure 71 according to the second embodiment is different from the electronic component mounting structure 70 according to the first embodiment described above in that the heat dissipation component 20 has a disk shape to match the shape of the electronic component 10 in the in-plane direction of the one surface 31 of the metal plate 30.

The electronic component mounting structure 71 having the configuration described above has the same structure as the electronic component mounting structure 70 according to the first embodiment described above except that the heat dissipation component 20 has the disk shape in the in-plane direction of the one surface 31 of the metal plate 30. Therefore, the electronic component mounting structure 71 has an effect similar to that of the electronic component mounting structure 70 according to the first embodiment.

Also, the electronic component mounting structure 71 uses the heat dissipation component 20 having the shape along the shape of the electronic component 10 in the in-plane direction of the one surface 31 of the metal plate 30. Therefore, in the electronic component mounting structure 71, the heat dissipation component 20 can be reduced in size while leaving a portion of the heat dissipation component 20 that effectively dissipates the heat generated in the electronic component 10. The portion of the heat dissipation component 20 that effectively dissipates the heat generated in the electronic component 10 is a region of the heat dissipation component 20 corresponding to the annular shape of the electronic component 10 in the in-plane direction of the one surface 31 of the metal plate 30.

That is, in the electronic component mounting structure 71, the electronic component 10 has a disk shape in the in-plane direction of the one surface 31 of the metal plate 30. It can then be said that the heat dissipation component 20 has the disk shape that is larger than the disk shape of the electronic component 10 and follows the shape of the electronic component 10 in the in-plane direction of the one surface 31 of the metal plate 30. In the in-plane direction of the one surface 31 of the metal plate 30, the disk shape of the electronic component 10 and the disk shape of the heat dissipation component 20 are disposed coaxially.

As a result, the electronic component mounting structure 71 can, at a lower cost than the electronic component mounting structure 70 according to the first embodiment described above, enhance the performance of dissipating the heat of the electronic component 10 by enhancing the heat transfer performance from the electronic component 10 to the metal plate 30 and also suppress the vibration of the electronic component 10. Therefore, the electronic component mounting structure 71 can, at a lower cost than the electronic component mounting structure 70, prevent the connection terminals 41 or the terminal blocks 42, which are the connector between the electronic component 10 and the electronic substrates 43, from experiencing a fatigue failure due to the vibration of the electronic component 10 during product transportation.

### Third Embodiment

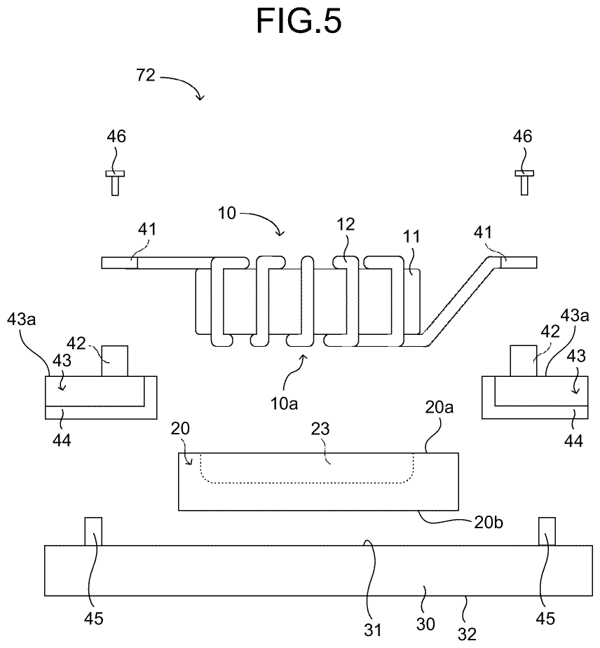

FIG. 5 is an exploded side view illustrating an electronic component mounting structure 72 according to a third embodiment. Note that in the third embodiment, components identical to those in the first embodiment described above are denoted by the same reference numerals as those assigned to such components in the first embodiment, and a detailed description thereof will be omitted.

The electronic component mounting structure 72 according to the third embodiment is different from the electronic component mounting structure 70 according to the first embodiment described above in that a recess 23 having a shape along the shape of the lower portion of the electronic component 10 is formed in the heat dissipation component 20 on the side of the upper surface 20a.

The electronic component mounting structure 72 having the configuration described above has the same structure as the electronic component mounting structure 70 according to the first embodiment described above except that the recess 23 having the shape along the shape of the lower portion of the electronic component 10 is formed in the heat dissipation component 20 on the side of the upper surface 20a. Therefore, the electronic component mounting structure 72 has an effect similar to that of the electronic component mounting structure 70 according to the first embodiment.

In the electronic component mounting structure 72 having the configuration described above, it can be said that the heat dissipation component 20 includes the recess 23 formed along the shape of a contact portion where the electronic component 10 is in contact with the heat dissipation component 20. Therefore, in the electronic component mounting structure 72, the heat dissipation component 20 is more easily brought into intimate contact with the lower portion of the electronic component 10. As a result, the electronic component mounting structure 72 can, more effectively than the electronic component mounting structure 70 according to the first embodiment described above, enhance the performance of dissipating the heat of the electronic component 10 by enhancing the heat transfer performance from the electronic component 10 to the metal plate 30 and also suppress the vibration of the electronic component 10. Therefore, the electronic component mounting structure 72 can, more effectively than the electronic component mounting structure 70, prevent the connection terminals 41 or the terminal blocks 42, which are the connector between the electronic component 10 and the electronic substrates 43, from experiencing a fatigue failure due to the vibration of the electronic component 10 during product transportation.

### Fourth Embodiment

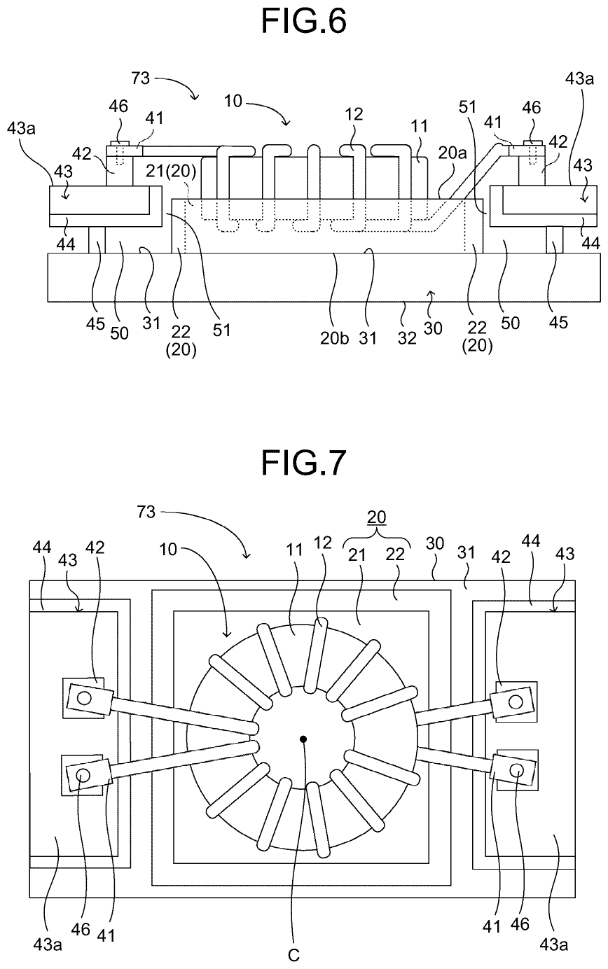

FIG. 6 is a side view illustrating an electronic component mounting structure 73 according to a fourth embodiment. FIG. 7 is a top view illustrating the electronic component mounting structure 73 according to the fourth embodiment. Note that in the fourth embodiment, components identical to those in the first embodiment described above are denoted by the same reference numerals as those assigned to such components in the first embodiment, and a detailed description thereof will be omitted.

The electronic component mounting structure 73 according to the fourth embodiment is different from the electronic component mounting structure 70 according to the first embodiment described above in that the heat dissipation component 20 includes a first heat dissipation component 21 and a second heat dissipation component 22 as two types of the heat dissipation components 20 having different flexibility and elasticity, the first heat dissipation component 21 having relatively high flexibility is disposed at a portion in contact with the electronic component 10, and the second heat dissipation component 22 having relatively high elasticity is disposed at a portion not in contact with the electronic component 10.

The electronic component mounting structure 73 having the configuration described above has the same structure as the electronic component mounting structure 70 according to the first embodiment described above except that the heat dissipation component 20 includes the first heat dissipation component 21 and the second heat dissipation component 22 as the two types of the heat dissipation components 20 having different flexibility and elasticity, and the first heat dissipation component 21 having relatively high flexibility is disposed on a surface in contact with the electronic component 10. Therefore, the electronic component mounting structure 73 has an effect similar to that of the electronic component mounting structure 70 according to the first embodiment.

The first heat dissipation component 21 is the heat dissipation component 20 having flexibility and elasticity in the electronic component mounting structure 73, and is the heat dissipation component 20 having relatively higher flexibility than the second heat dissipation component 22.

Moreover, the second heat dissipation component 22 is the heat dissipation component 20 having flexibility and elasticity in the electronic component mounting structure 73, and is the heat dissipation component 20 having relatively higher elasticity than the first heat dissipation component 21.

Then, in the electronic component mounting structure 73, the first heat dissipation component 21 having relatively high flexibility is disposed at the portion in contact with the electronic component 10. Specifically, in the electronic component mounting structure 73, the first heat dissipation component 21 is provided in a quadrangular shape containing the core 11 of the electronic component 10 in the in-plane direction of the one surface 31 of the metal plate 30.

By including the heat dissipation component 20 having such a configuration, the electronic component mounting structure 73 secures a large contact area between the heat dissipation component 20 and the electronic component 10 and also enhances the adhesion between the heat dissipation component 20 and the electronic component 10, as described in the first embodiment. As a result, the electronic component mounting structure 73 can efficiently transfer the heat generated in the electronic component 10 during the operation of the electronic component 10 to the metal plate 30 via the heat dissipation component 20, can reduce the thermal resistance between the electronic component 10 and the metal plate 30, and can enhance the performance of dissipating the heat generated in the electronic component 10.

Moreover, in the electronic component mounting structure 73, the second heat dissipation component 22 having relatively high elasticity is disposed at the portion not in contact with the electronic component 10. Specifically, in the electronic component mounting structure 73, the second heat dissipation component 22 is formed in a frame shape that encloses the quadrangular shape of the first heat dissipation component 21 from an outer edge side of the first heat dissipation component 21 in the in-plane direction of the one surface 31 of the metal plate 30. That is, the first heat dissipation component 21 and the second heat dissipation component 22 are placed in a way that, in the in-plane direction of the one surface 31 of the metal plate 30, the first heat dissipation component 21 having relatively high flexibility is placed in a region close to the central axis C of the electronic component 10, and the second heat dissipation component 22 having relatively high elasticity is placed in a region far from the central axis C of the electronic component 10. Note that the height of the first heat dissipation component 21 is set equal to the height of the second heat dissipation component 22.

With the second heat dissipation component 22 configured as described above, in the electronic component mounting structure 73, when vibration is applied to the electronic component mounting structure 73, deformation of the first heat dissipation component 21 due to flexibility thereof toward the outer edge of the quadrangular shape of the first heat dissipation component 21 in the in-plane direction of the one surface 31 of the metal plate 30 is prevented by elasticity of the second heat dissipation component 22 having relatively high elasticity. That is, in the electronic component mounting structure 73, deformation of the first heat dissipation component 21 is prevented by elasticity of the second heat dissipation component 22, so that vibration of the electronic component 10 can be suppressed.

As a result, as with the electronic component mounting structure 73 according to the first embodiment described above, the electronic component mounting structure 73 can suppress the vibration of the electronic component 10 even when vibration is applied to the electronic component mounting structure 70. Thus, with the vibration of the electronic component 10 being suppressed, the connection terminals 41 or the terminal blocks 42, which are the connector between the electronic component 10 and the electronic substrates 43, do not experience a fatigue failure due to the vibration of the electronic component 10. Therefore, the electronic component mounting structure 73 in which the heat dissipation component 20 includes the first heat dissipation component 21 and the second heat dissipation component 22 also obtains an effect similar to that of the heat dissipation component 20 of the electronic component mounting structure 70 according to the first embodiment.

Note that the above description has described the case where, in the in-plane direction of the one surface 31 of the metal plate 30, the first heat dissipation component 21 is placed in the region close to the central axis C of the electronic component 10, and the second heat dissipation component 22 is placed in the region far from the central axis C of the electronic component 10, but the placement of the first heat dissipation component 21 and the second heat dissipation component 22 is not limited to the placement described above. The placement of the first heat dissipation component 21 and the second heat dissipation component 22 can be changed as appropriate without departing from the essence and scope of the effect of the electronic component mounting structure 73 according to the fourth embodiment described above.

### Fifth Embodiment

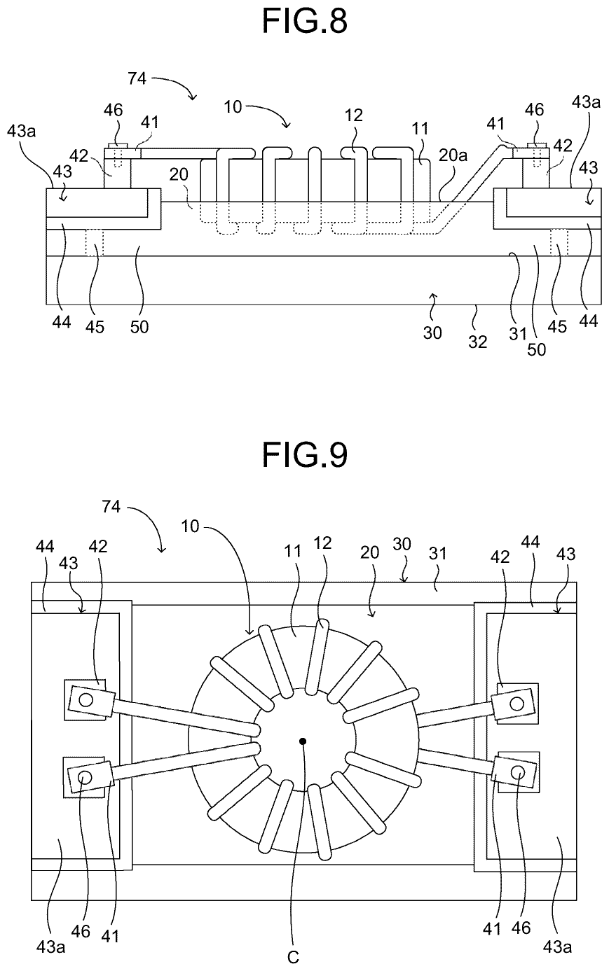

FIG. 8 is a side view illustrating an electronic component mounting structure 74 according to a fifth embodiment. FIG. 9 is a top view illustrating the electronic component mounting structure 74 according to the fifth embodiment. Note that in the fifth embodiment, components identical to those in the first embodiment described above are denoted by the same reference numerals as those assigned to such components in the first embodiment, and a detailed description thereof will be omitted.

The electronic component mounting structure 74 according to the fifth embodiment is different from the electronic component mounting structure 70 according to the first embodiment described above in that the heat dissipation component 20 is also disposed between the substrate holders 44, which fix and hold the electronic substrates 43, and the metal plate 30 in the in-plane direction of the one surface 31 of the metal plate 30.

The electronic component mounting structure 74 having the configuration described above has the same structure as the electronic component mounting structure 70 according to the first embodiment described above except that the heat dissipation component 20 is also disposed between the substrate holders 44, which fix and hold the electronic substrates 43, and the metal plate 30 in the in-plane direction of the one surface 31 of the metal plate 30. Therefore, the electronic component mounting structure 74 has an effect similar to that of the electronic component mounting structure 70 according to the first embodiment.

In the electronic component mounting structure 74, the heat dissipation component 20 disposed in the gaps 50 between the substrate holders 44 and the metal plate 30 is deformed by the downward pressing force received from the substrate holders 44 and is in intimate contact with the one surface 31 of the metal plate 30. As a result, the electronic substrates 43 held by the substrate holders 44 are thermally connected to the one surface 31 of the metal plate 30 via the substrate holders 44 and the heat dissipation component 20. The downward pressing force received from the substrate holders 44 is a pressing force received from the substrate holders 44 in a direction perpendicular to the in-plane direction of the one surface 31 of the metal plate 30, and is a pressing force in a direction from the heat dissipation component 20 toward the metal plate 30.

In the electronic component mounting structure 74, after the heat dissipation component 20 is disposed on the one surface 31 of the metal plate 30 including the gaps 50 between the substrate holders 44 and the metal plate 30, the substrate holders 44 are attached and fixed to the metal plate 30 via the columns 45 fixed to the one surface 31 of the metal plate 30. As a result, the downward pressing force described above is applied to the heat dissipation component 20 between the substrate holders 44 and the metal plate 30 from the side of the upper surface 20a of the heat dissipation component 20 toward the metal plate 30. Note that in this case, the heat dissipation component 20 disposed between the substrate holders 44 and the metal plate 30 is provided with through holes through which the columns 45 pass.

Therefore, in the fifth embodiment, the electronic component mounting structure is realized in which the substrate holders 44 are provided above and away from the one surface 31 of the metal plate 30, a part of the heat dissipation component 20 is sandwiched between the lower surfaces of the electronic substrates 43 protruding from the substrate holders 44 in the in-plane direction of the metal plate 30 or the lower surfaces of the substrate holders 44 and the one surface 31 of the metal plate 30, is deformed by the force applied downward from the substrate holders 44, and is in intimate contact with the one surface 31 of the metal plate 30, and the electronic component 10 and the electronic substrates 43 are electrically connected via a part of the heat dissipation component 20.

In the electronic component mounting structure 74, the heat dissipation component 20 disposed between the substrate holders 44 and the metal plate 30 is deformed by the downward pressing force received from the substrate holders 44, so that the adhesion between the heat dissipation component 20 and the metal plate 30 is further improved. As a result, the electronic component mounting structure 74 can more reliably, than the electronic component mounting structure 70 according to the first embodiment described above, enhance the performance of dissipating the heat of the electronic component 10 by enhancing the heat transfer performance from the electronic component 10 to the metal plate 30 and also suppress the vibration of the electronic component 10. Therefore, the electronic component mounting structure 74 can more reliably, than the electronic component mounting structure 70, prevent the connection terminals 41 or the terminal blocks 42, which are the connector between the electronic component 10 and the electronic substrates 43, from experiencing a fatigue failure due to the vibration of the electronic component 10 during product transportation.

Moreover, in the electronic component mounting structure 74, the heat dissipation component 20 is in the gaps 50 between the substrate holders 44 and the metal plate 30, whereby the electronic substrates 43 are thermally connected to the one surface 31 of the metal plate 30 via the substrate holders 44 and the heat dissipation component 20 disposed in the gaps 50. Therefore, in the electronic component mounting structure 74, heat generated in the electronic substrates 43 during the operation of the electronic substrates 43 can be transferred to the metal plate 30 via the substrate holders 44 and the heat dissipation component 20 disposed in the gaps 50. As a result, the electronic component mounting structure 74 can enhance the performance of dissipating the heat generated in the electronic substrates 43 and cool the electronic substrates 43. By cooling the electronic substrates 43, the electronic component mounting structure 74 can prevent an increase in temperature of the electronic substrates 43 and prevent malfunction of the electronic substrates 43 due to an increase in temperature of the electronic substrates 43.

### Sixth Embodiment

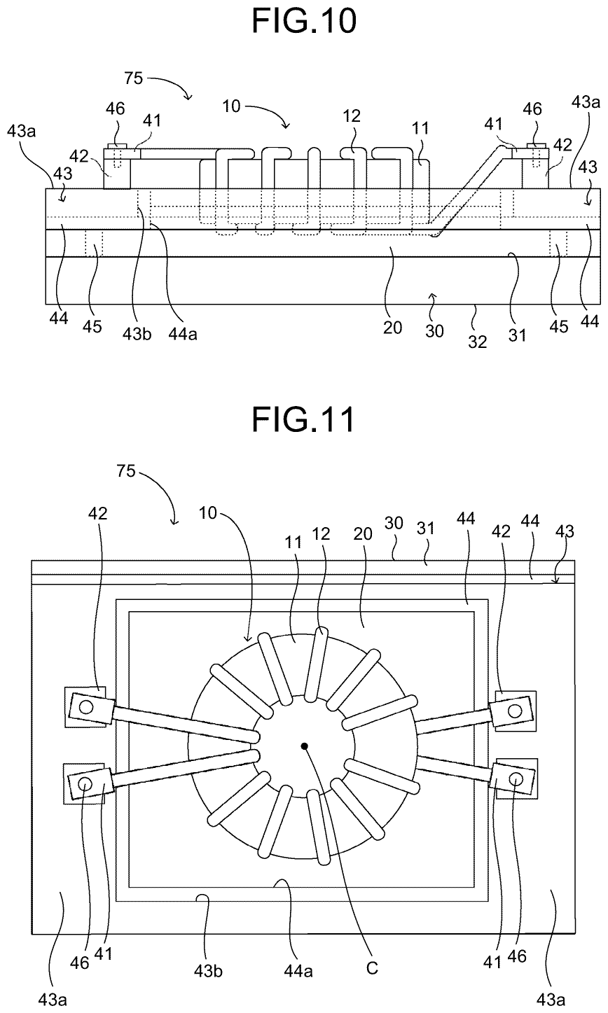

FIG. 10 is a side view illustrating an electronic component mounting structure 75 according to a sixth embodiment. FIG. 11 is a top view illustrating the electronic component mounting structure 75 according to the sixth embodiment. Note that in the sixth embodiment, components identical to those in the first embodiment described above are denoted by the same reference numerals as those assigned to such components in the first embodiment, and a detailed description thereof will be omitted.

The electronic component mounting structure 75 according to the sixth embodiment is different from the electronic component mounting structure 70 according to the first embodiment described above in that the electronic substrate 43 and the substrate holder 44 each include an opening formed in a region corresponding to a position where the electronic component 10 is disposed.

That is, in the first embodiment, as illustrated in FIGS. 1 and 2, the two pieces of the electronic substrates 43 are disposed so as to sandwich the heat dissipation component 20 and the electronic component 10 in the in-plane direction of the one surface 31 of the metal plate 30. Also, in the first embodiment, as illustrated in FIGS. 1 and 2, the two pieces of the substrate holders 44 are disposed so as to sandwich the heat dissipation component 20 and the electronic component 10 in the in-plane direction of the one surface 31 of the metal plate 30.

On the other hand, in the electronic component mounting structure 75, as illustrated in FIGS. 10 and 11, one piece of the substrate holder 44 is disposed above the one surface 31 of the metal plate 30. Also, in the electronic component mounting structure 75, as illustrated in FIGS. 10 and 11, one piece of the electronic substrate 43 is held by the one piece of the substrate holder 44.

In addition, in the electronic substrate 43, an opening 43b is formed in the region corresponding to the position where the electronic component 10 is disposed in the in-plane direction of the one surface 31 of the metal plate 30. Likewise, in the substrate holder 44, an opening 44a is formed in the region corresponding to the position where the electronic component 10 is disposed in the in-plane direction of the one surface 31 of the metal plate 30.

The opening 43b of the electronic substrate 43 is formed at the position containing the opening 44a of the substrate holder 44 in the in-plane direction of the one surface 31 of the metal plate 30. Also, the opening 44a of the substrate holder 44 and the opening 43b of the electronic substrate 43 are formed at the positions containing the core 11 of the electronic component 10 in the in-plane direction of the one surface 31 of the metal plate 30.

Also, in the electronic component mounting structure 75, as with the electronic component mounting structure 74 according to the fifth embodiment described above, the heat dissipation component 20 is also disposed between the substrate holder 44, which fixes and holds the electronic substrate 43, and the metal plate 30 in the in-plane direction of the one surface 31 of the metal plate 30. The electronic component 10 is disposed while protruding upward from the opening 44a of the substrate holder 44 and the opening 43b of the electronic substrate 43. Moreover, a part of the heat dissipation component 20 is exposed from the opening 44a of the substrate holder 44 and the opening 43b of the electronic substrate 43.

In the electronic component mounting structure 75 having the configuration described above, the electronic component 10 is disposed inside the opening 44a formed in the substrate holder 44 and the opening 43b formed in the electronic substrate 43 in the in-plane direction of the one surface 31 of the metal plate 30, whereby the electronic component 10 and the electronic substrate 43 can be attached closer to each other. As a result, the electronic component mounting structure 75 can realize the mounting structure of the electronic component 10 in a small size and at a low cost.

Note that the above description has described the case where the opening 44a is formed in the substrate holder 44 and the opening 43b is formed in the electronic substrate 43, but the structure that allows the electronic component 10 and the electronic substrate 43 to be attached close to each other as described above is not limited to the structure in which the opening 44a and the opening 43b are formed.

For example, in the electronic component mounting structure 70 illustrated in FIG. 1 and FIG. 2 of the first embodiment described above, a case will be considered in which the electronic component 10 is brought closer to the substrate holders 44 and the electronic substrates 43 in a way that the electronic substrates 43 and the substrate holders 44 do not overlap with the electronic component 10 in the in-plane direction of the one surface 31 of the metal plate 30.

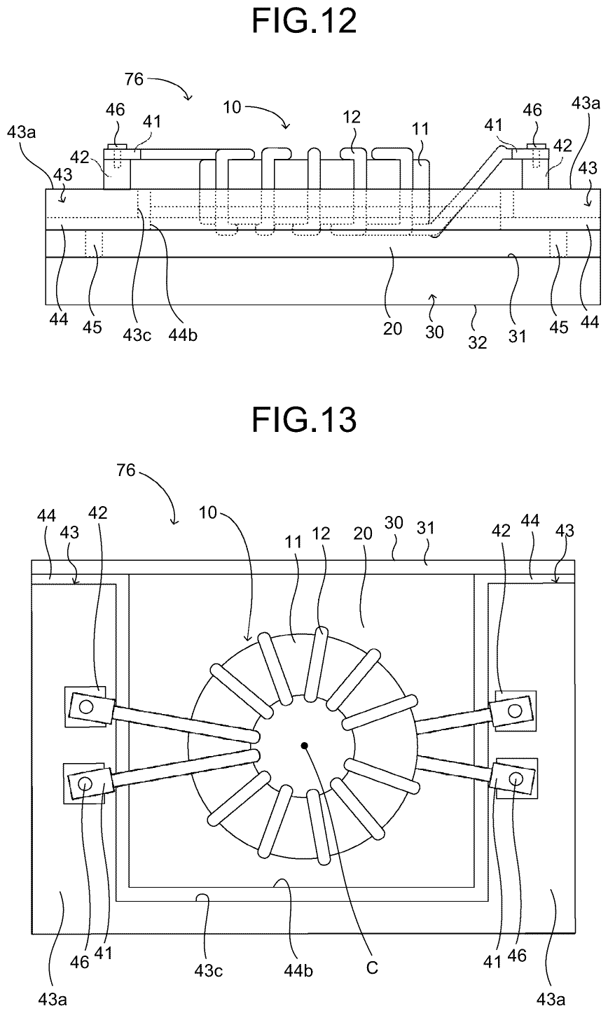

FIG. 12 is a side view illustrating another electronic component mounting structure 76 according to the sixth embodiment. FIG. 13 is a top view illustrating the another electronic component mounting structure 76 according to the sixth embodiment. The another electronic component mounting structure 76 according to the sixth embodiment is different from the electronic component mounting structure 75 according to the sixth embodiment described above in that the electronic substrate 43 and the substrate holder 44 each include a cutout formed in the region corresponding to the position where the electronic component 10 is disposed.

As illustrated in FIGS. 12 and 13, in the another electronic component mounting structure 76, one piece of the substrate holder 44 is disposed above the one surface 31 of the metal plate 30 as with the electronic component mounting structure 75 according to the sixth embodiment described above. Also, as illustrated in FIGS. 12 and 13, in the another electronic component mounting structure 76, one piece of the electronic substrate 43 is held by the one piece of the substrate holder 44 as with the electronic component mounting structure 75 according to the sixth embodiment described above.

In addition, in the electronic substrate 43, a cutout 43c is formed in the region corresponding to the position where the electronic component 10 is disposed in the in-plane direction of the one surface 31 of the metal plate 30. Likewise, in the substrate holder 44, a cutout 44b is formed in the region corresponding to the position where the electronic component 10 is disposed in the in-plane direction of the one surface 31 of the metal plate 30.

The cutout 43c of the electronic substrate 43 is formed at a position containing the cutout 44b of the substrate holder 44 except for a part of the side on which the cutout 43c is open in the in-plane direction of the one surface 31 of the metal plate 30. Also, the cutout 44b of the substrate holder 44 and the cutout 43c of the electronic substrate 43 are formed at positions containing the core 11 of the electronic component 10 in the in-plane direction of the one surface 31 of the metal plate 30.

As with the electronic component mounting structure 75 according to the sixth embodiment described above, in the another electronic component mounting structure 76, the heat dissipation component 20 is also disposed between the substrate holder 44, which fixes and holds the electronic substrate 43, and the metal plate 30 in the in-plane direction of the one surface 31 of the metal plate 30. The electronic component 10 is disposed while protruding upward from the cutout 44b of the substrate holder 44 and the cutout 43c of the electronic substrate 43. Moreover, a part of the heat dissipation component 20 is exposed from the cutout 44b of the substrate holder 44 and the cutout 43c of the electronic substrate 43.

In the another electronic component mounting structure 76 having the configuration described above, the electronic component 10 is disposed inside the cutout 44b formed in the substrate holder 44 and the cutout 43c formed in the electronic substrate 43 in the in-plane direction of the one surface 31 of the metal plate 30, whereby the electronic component 10 and the electronic substrate 43 can be attached closer to each other as with the electronic component mounting structure 75 according to the sixth embodiment described above. As a result, the another electronic component mounting structure 76 can realize the mounting structure of the electronic component 10 in a small size and at a low cost, as with the electronic component mounting structure 75 according to the sixth embodiment described above.

Therefore, in the sixth embodiment, the electronic component mounting structure is realized in which the opening or the cutout is formed in each of the the electronic substrate 43 and the substrate holder 44 at the position where the electronic component 10 is disposed in the in-plane direction of the metal plate 30.

The structure with the opening 44a formed in the substrate holder 44 and the opening 43b formed in the electronic substrate 43, or the structure with the cutouts formed in the substrate holder 44 and the electronic substrate 43 may be selected at will.

### Seventh Embodiment

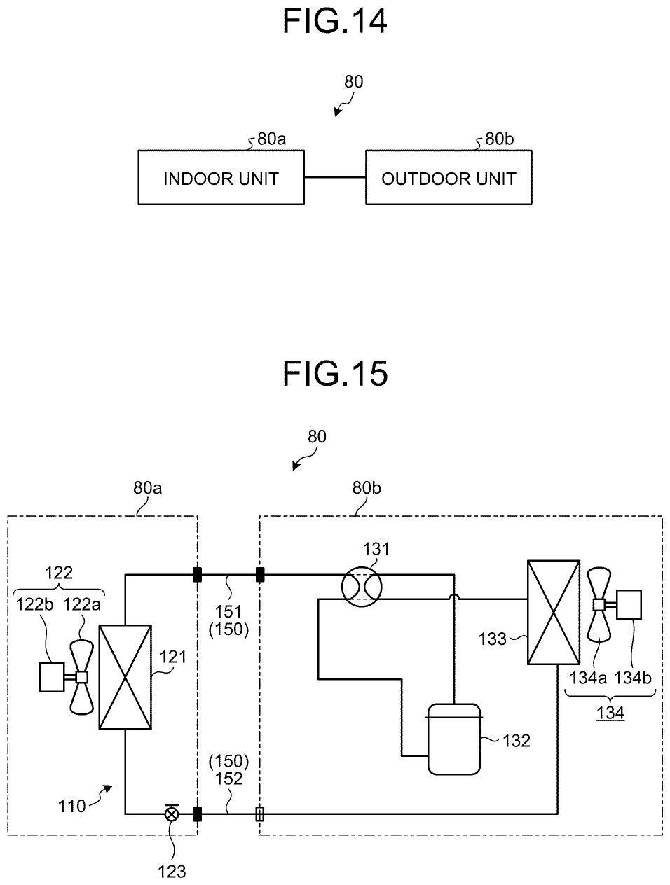

FIG. 14 is a block diagram illustrating a configuration of an air conditioner 80 according to a seventh embodiment. FIG. 15 is a refrigerant circuit diagram illustrating a refrigeration cycle 110 of the air conditioner 80 according to the seventh embodiment. As illustrated in FIGS. 14 and 15, the air conditioner 80 according to the seventh embodiment includes an indoor unit 80a installed indoors and an outdoor unit 80b installed outdoors. Note that, in the drawings, common elements are assigned the same reference numerals, and redundant description will be omitted.

In the air conditioner 80, the indoor unit 80a, refrigerant piping 152, the outdoor unit 80b, and refrigerant piping 151 form a refrigerant circulation circuit. Also, in the air conditioner 80, a compressor 132, a four-way valve 131, an outdoor heat exchanger 133, an expansion valve 123, and an indoor heat exchanger 121 are sequentially connected in a loop using the refrigerant piping 151 and the refrigerant piping 152 to form the refrigeration cycle 110. The refrigerant piping 151 and the refrigerant piping 152 are piping for connecting the indoor heat exchanger 121 of the indoor unit 80a and the outdoor heat exchanger 133 of the outdoor unit 80b and circulating the refrigerant, and serve as a part of a refrigerant circuit in the refrigeration cycle 110 of the air conditioner 80.

Moreover, in the indoor unit 80a, an indoor blower 122 is installed for forming an airflow that passes through the indoor heat exchanger 121. The indoor blower 122 operates when an indoor propeller 122a is driven by an indoor motor 122b.

Also, in the outdoor unit 80b, an outdoor blower 134 is installed for forming an airflow that passes through the outdoor heat exchanger 133. The outdoor blower 134 operates when an outdoor propeller 134a is driven by an outdoor motor 134b.

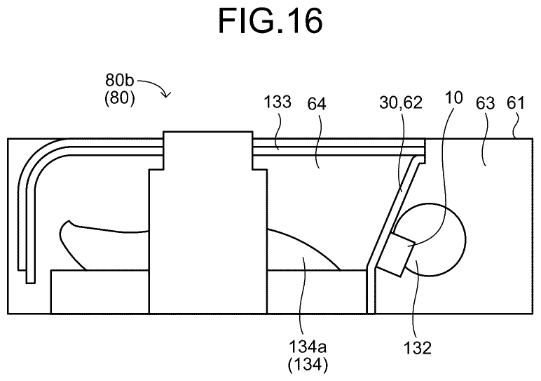

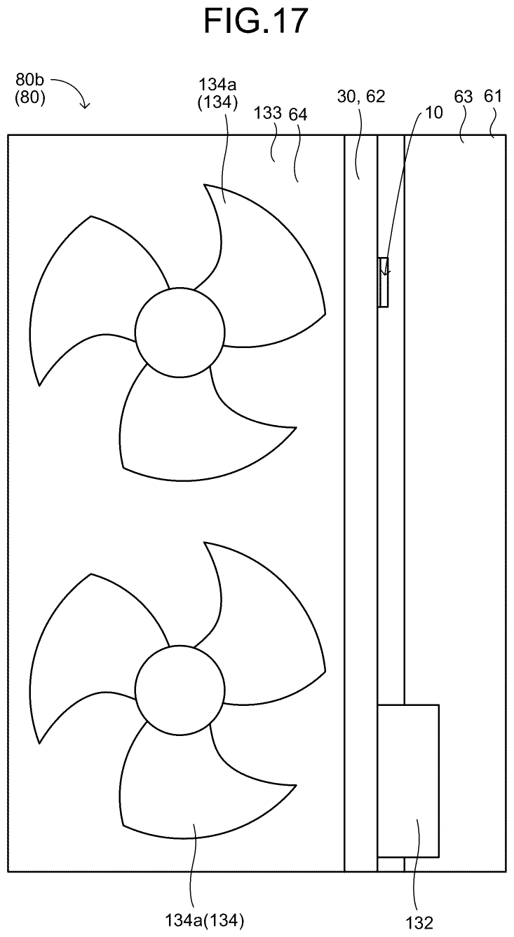

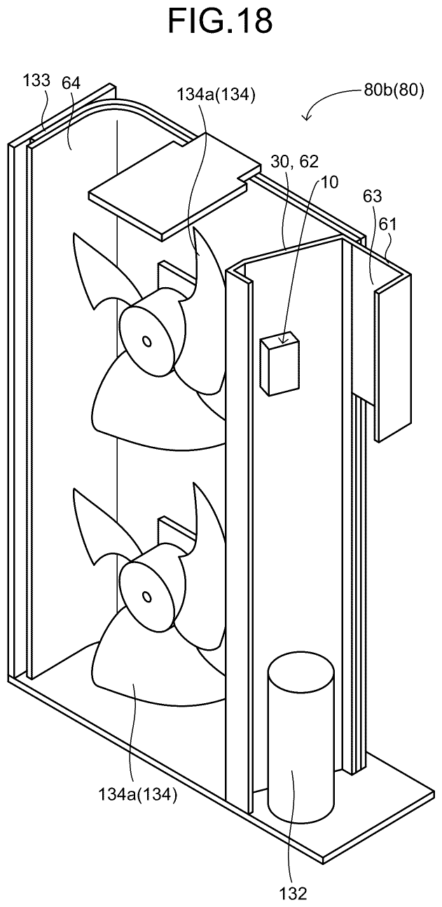

FIG. 16 is a first conceptual diagram illustrating a configuration of the outdoor unit 80b of the air conditioner 80 to which the electronic component mounting structure according to any one of the first embodiment to the sixth embodiment is attached. FIG. 16 illustrates the conceptual diagram when the outdoor unit 80b is viewed from above. FIG. 17 is a second conceptual diagram illustrating the configuration of the outdoor unit 80b of the air conditioner 80 to which the electronic component mounting structure according to any one of the first embodiment to the sixth embodiment is attached. FIG. 17 illustrates the conceptual diagram when the outdoor unit 80b is viewed from the side. FIG. 18 is a third conceptual diagram illustrating the configuration of the outdoor unit 80b of the air conditioner 80 to which the electronic component mounting structure according to any one of the first embodiment to the sixth embodiment is attached. FIG. 18 illustrates the conceptual diagram when the outdoor unit 80b is viewed obliquely from above. FIGS. 16 to 18 illustrate a part of the structure of the outdoor unit 80b seen when a part of a housing 61 of the outdoor unit 80b is removed.

The outdoor unit 80b of the air conditioner 80 has a structure in which the metal plate 30 of the electronic component mounting structure according to any one of the first embodiment to the sixth embodiment serves as a partition, and the inside of the housing 61 having the shape of a rectangular parallelepiped box is divided into a machine chamber 63 and a blower chamber 64. In the case where the metal plate 30 serves as the partition, reference characters “30, 62” in FIGS. 16 to 18 are to be understood as reference character “30”. Inside the housing 61, the electronic component 10 is disposed in the machine chamber 63, and the outdoor blower 134 is disposed in the blower chamber 64. Also, the compressor 132 is disposed in the machine chamber 63. Moreover, the outdoor heat exchanger 133 is disposed in the blower chamber 64.

In the outdoor unit 80b configured as described above, heat generated in the electronic component 10 and transferred to the metal plate 30 via the heat dissipation component 20 is discharged to the air on the side of the blower chamber 64, whereby the performance of dissipating the heat of the electronic component 10 or the metal plate 30 is greatly improved, and the electronic component 10 can be efficiently cooled. Note that a heat radiator may be attached to the metal plate 30. The heat radiator includes, for example, a metal heat sink.

Moreover, in the outdoor unit 80b of the air conditioner 80, the another surface 32 side of the metal plate 30 may be attached to an attachment plate 62, and the attachment plate 62 may serve as a partition to divide the inside of the housing 61 having the shape of the rectangular parallelepiped box into the machine chamber 63 and the blower chamber 64. In the case where the attachment plate 62 serves as the partition, reference characters “30, 62” in FIGS. 16 to 18 are to be understood as reference character “62”.

In the outdoor unit 80b configured as described above, the another surface 32 side of the metal plate 30 is attached to the attachment plate 62, so that the electronic component mounting structure can be detachably attached to the outdoor unit 80b more easily, and assemblability of the outdoor unit 80b and maintenance service performance of the outdoor unit 80b can be improved.

The structure of attaching the another surface 32 of the metal plate 30 to the attachment plate 62 includes screwing and the like, but the structure of attaching the another surface 32 of the metal plate 30 to the attachment plate 62 is not limited. The structure of attaching the another surface 32 of the metal plate 30 to the attachment plate 62 can be changed as appropriate without departing from the essence and scope of the effect of the structure of attaching the another surface 32 of the metal plate 30 to the attachment plate 62.

The configurations illustrated in the above embodiments each illustrate an example so that another known technique can be combined, the embodiments can be combined together, or the configurations can be partially omitted and/or modified without departing from the scope of the present disclosure.

1. An electronic component mounting structure comprising:
an electronic component;
a metal plate including one surface and another surface; and
a heat dissipation component having flexibility and elasticity,
a substrate holder disposed above the one surface of the metal plate; and an electronic substrate held on the substrate holder, wherein
the heat dissipation component is sandwiched between the one surface of the metal plate and the electronic component with a region of the heat dissipation component that faces the electronic component being deformed along a shape of the electronic component and being in intimate contact with the electronic component, and the heat dissipation component being in intimate contact with the one surface of the metal plate,
the electronic component and the metal plate are thermally connected via the heat dissipation component, and
the electronic component and the electronic substrate are electrically connected via a connector between the electronic component and the electronic substrate.

2. The electronic component mounting structure according to claim 1, wherein
the electronic component is a coil including a core made of a magnetic material and a winding wound around the core.

3. (canceled)

4. The electronic component mounting structure according to claim 1, wherein
the electronic component has an annular shape in an in-plane direction of the metal plate, and is disposed in a state in which a lower surface of the electronic component orthogonal to a central axis of the annular shape of the electronic component faces and is in contact with an upper surface of the heat dissipation component.

5. The electronic component mounting structure according to claim 4, wherein
the heat dissipation component has a disk shape along the shape of the electronic component in the in-plane direction of the metal plate.

6. (canceled)

7. (canceled)

8. The electronic component mounting structure according to claim 1, wherein
the substrate holder is provided above and away from the one surface of the metal plate,
a part of the heat dissipation component is sandwiched between the one surface of the metal plate and a lower surface of the electronic substrate that protrudes from the substrate holder in an in-plane direction of the metal plate or a lower surface of the substrate holder, is deformed by a force applied downward from the substrate holder, and is in intimate contact with the one surface of the metal plate, and
the electronic component and the electronic substrate are thermally connected via a part of the heat dissipation component.

9. The electronic component mounting structure according to claim 1, wherein
the electronic substrate and the substrate holder each include
an opening or a cutout formed at a position at which the electronic component is disposed in an in-plane direction of the metal plate.

10. An outdoor unit of an air conditioner, the outdoor unit comprising:
a housing; and
the electronic component mounting structure according to claim 1 accommodated in the housing, wherein
a blower chamber and a machine chamber partitioned by the metal plate of the electronic component mounting structure are formed inside the housing,
the electronic component is disposed in the machine chamber, and
a blower is disposed in the blower chamber.

11. An outdoor unit of an air conditioner, the outdoor unit comprising:
a housing;
the electronic component mounting structure according to claim 1 accommodated in the housing; and
an attachment plate to which the metal plate of the electronic component mounting structure is attached, wherein
a blower chamber and a machine chamber partitioned by the attachment plate are formed inside the housing,
the electronic component is disposed in the machine chamber, and
a blower is disposed in the blower chamber.

12. An electronic component mounting structure comprising:
an electronic component;
a metal plate including one surface and another surface; and
a heat dissipation component having flexibility and elasticity, wherein
the heat dissipation component is sandwiched between the one surface of the metal plate and the electronic component with a region of the heat dissipation component that faces the electronic component being deformed along a shape of the electronic component and being in intimate contact with the electronic component, and the heat dissipation component being in intimate contact with the one surface of the metal plate, wherein
the heat dissipation component includes a recess formed along a shape of a contact portion in which the electronic component is in contact with the heat dissipation component, and
the electronic component and the metal plate are thermally connected via the heat dissipation component.

13. An electronic component mounting structure comprising:
an electronic component;
a metal plate including one surface and another surface; and
a heat dissipation component having flexibility and elasticity, wherein
the heat dissipation component is sandwiched between the one surface of the metal plate and the electronic component with a region of the heat dissipation component that faces the electronic component being deformed along a shape of the electronic component and being in intimate contact with the electronic component, and the heat dissipation component being in intimate contact with the one surface of the metal plate, and
the heat dissipation component includes, as two types of heat dissipation components having different flexibility and elasticity, a first heat dissipation component having relatively high flexibility and a second heat dissipation component having relatively high elasticity,
the first heat dissipation component is disposed on a surface in contact with the electronic component,
the electronic component and the metal plate are thermally connected via the heat dissipation component.

14. The electronic component mounting structure according to claim 12, wherein
the electronic component has an annular shape in an in-plane direction of the metal plate, and is disposed in a state in which a lower surface of the electronic component orthogonal to a central axis of the annular shape of the electronic component faces and is in contact with an upper surface of the heat dissipation component.

15. The electronic component mounting structure according to claim 13, wherein
the electronic component has an annular shape in an in-plane direction of the metal plate, and is disposed in a state in which a lower surface of the electronic component orthogonal to a central axis of the annular shape of the electronic component faces and is in contact with an upper surface of the heat dissipation component.

16. An outdoor unit of an air conditioner, the outdoor unit comprising:
a housing; and
the electronic component mounting structure according to claim 12 accommodated in the housing, wherein
a blower chamber and a machine chamber partitioned by the metal plate of the electronic component mounting structure are formed inside the housing,
the electronic component is disposed in the machine chamber, and
a blower is disposed in the blower chamber.

17. An outdoor unit of an air conditioner, the outdoor unit comprising:
a housing; and
the electronic component mounting structure according to claim 13 accommodated in the housing, wherein
a blower chamber and a machine chamber partitioned by the metal plate of the electronic component mounting structure are formed inside the housing,
the electronic component is disposed in the machine chamber, and
a blower is disposed in the blower chamber.

18. An outdoor unit of an air conditioner, the outdoor unit comprising:
a housing;
the electronic component mounting structure according to claim 12 accommodated in the housing; and
an attachment plate to which the metal plate of the electronic component mounting structure is attached, wherein
a blower chamber and a machine chamber partitioned by the attachment plate are formed inside the housing,
the electronic component is disposed in the machine chamber, and
a blower is disposed in the blower chamber.

19. An outdoor unit of an air conditioner, the outdoor unit comprising:
a housing;
the electronic component mounting structure according to claim 13 accommodated in the housing; and
an attachment plate to which the metal plate of the electronic component mounting structure is attached, wherein
a blower chamber and a machine chamber partitioned by the attachment plate are formed inside the housing,
the electronic component is disposed in the machine chamber, and
a blower is disposed in the blower chamber.
